(19) United States
(12) Patent Application Publication
(10) Pub. No.: US 2020/0166005 A1
(43) Pub. Date: May 28, 2020

(54) DRIVE SHAFT COMPONENT AND METHOD OF PRODUCING THE DRIVE SHAFT COMPONENT

(71) Applicant: Rolls-Royce Deutschland Ltd & Co KG, Blankenfelde-Mahlow (DE)

(72) Inventors: Karl SCHREIBER, Am Mellensee (DE); Alexander SCHULT, Berlin (DE); Ulrich ADAMCZEWSKI, Berlin (DE)

(21) Appl. No.: 16/698,362

(22) Filed: Nov. 27, 2019

(30) Foreign Application Priority Data
Nov. 27, 2018 (DE) 10 2018 129 996.6

(51) Int. Cl. F02K 3/06; F02C 7/36

(52) U.S. Cl. CPC F02K 3/06; F02K 3/072; F02C 7/36

(57) ABSTRACT

A drive shaft component, which can be connected or is connected to the input side of a gear box in a gas turbine engine, in particular an aircraft engine, characterized in that the drive shaft component has partially a region including fiber reinforced plastic, the fibers in this region being arranged only in an angular range of +/−40° to 50°, in particular of +/−42° to 48°, most particularly +/−45°, in relation to the main axis of rotation of the drive shaft component. The invention also concerns a method for producing a drive shaft component and a gas turbine engine.

The present disclosure relates to a drive shaft component on the input or output side of a gear box in a gas turbine engine with the features of claim 1 and to a method for producing a drive shaft component with the features of claim 14.

In gas turbine engines, in particular in geared fan engines of aircraft, epicyclic gear boxes (planetary gear boxes) are used to reduce the relatively high speeds of a turbine for driving a fan of the engine. It is known In principle, for example from US 2009/0038435 A1 or WO 2010/0666724 A1, to use composite materials in connection with gear boxes.

There is however the problem of providing drive shafts which can in particular meet the special requirements for torque transmission.

This problem is addressed by a drive shaft component which can be connected or is connected to the input side of a gear box in a gas turbine engine, in particular an aircraft engine. In this case, the drive shaft component has at least one region comprising carbon-fiber reinforced plastic, the fibers in this region being arranged only, i.e. exclusively, in an angular range of +/−40° to 50°, in particular of +/−42° to 48°, most particularly +/−45°, in relation to the main axis of rotation of the drive shaft component.

Such a drive shaft component can be used even with the very great energy density resulting both from the weight requirements and the very limited installation space existing in the case of gear boxes (for example a planetary gear box) in gas turbine engines. There are also often very high mechanical loads, under temperatures of e.g. between −50° C. and +180° C., in a great range of rotational speeds and with high transmission loads. The structural restrictions on the diameter together with very high torques to be transmitted make very long tooth flanks necessary in the gear box. In order to ensure a uniform tooth engagement, it is consequently necessary to combine not only very rigidly designed components but also very flexible, compensating components. It should be pointed out that, in principle, the proportion of the volume that is made up by fibers can be variable.

The subject matter of claim 1 comprises a very torsionally rigid and at the same time (in the axial and radial direction) flexurally compliant type of construction. This combination of properties in a metallic type of construction is only possible with a large installation space and very high production costs, since the flexural elasticity requires a so-called bellows, which on account of its large outside diameter requires a large installation space.

In one embodiment, a metal insert is arranged at a load introduction point and/or a load delivery point (e.g. at a flange) of the drive shaft component. Consequently, a relatively high torque can be transmitted in the connection region.

In one embodiment, the fibers are at least partially formed as monolayers.

Furthermore, in one embodiment of the drive shaft component (for example a hollow shaft), between the load introduction point and the load delivery point there may be arranged a conical region, which tapers in the axial direction from the load introduction point to the load delivery point. This allows the available installation space to be used well.

In the case of an embodiment with a conical region, at the axial center of the conical region the fibers lie in an angular range of +/−40° to 50°, in particular of +/−42° to 48°, most particularly 45°, in relation to the main axis of rotation, the angle becoming greater in the direction of a larger diameter and the angle becoming smaller in the direction of a smaller diameter. In particular, the fiber volume content remains at a maximum in the conical region, even independently of the angle of the fiber deposition.

The drive shaft component may for example be designed as a hollow shaft, the wall thickness being constant or increasing from the load introduction point to the load delivery point.

In a further embodiment, additional layers of fibers, in particular of a load-adapted orientation, may be arranged in the load introduction region and/or the load delivery region of the drive shaft component.

The drive shaft component may in particular be designed as part of a drive shaft for a gear box (e.g. an epicyclic gear box), i.e. the drive shaft component may in particular be used in a geared turbofan engine.

In one embodiment, the fiber-reinforced plastic may comprise carbon fibers, metal filaments, synthetic fibers, in particular aramids and/or ceramic fibers.

In a further embodiment, a form-fitting connection element, in particular for a polygonal connection, is arranged at the load introduction point and/or at the load delivery point of the drive shaft component. This allows high torques to be transmitted to and provided by the gear box. In this case, the form-fitting connection element may take the form of a profiling of the outer side of the drive shaft component. The profiling may be formed for example as a pattern of teeth or a polygonal cross section. A metal supporting element and/or a supporting element of fiber composite material (e.g. with a 90° winding) may also be arranged in the interior of the drive shaft component. To prevent profiled parts, such as e.g. teeth, from shearing off, a pretensioning force may for example be applied to the drive shaft component.

The problem is also addressed in a method with the features of claim 15. In this case, in one region of the drive shaft component carbon fibers are incorporated in a matrix, the fibers in this region being arranged only (i.e. exclusively) in an angular range of +/−40° to 50°, in particular of +/−42° to 48°, most particularly +/−45°, in relation to the main axis of rotation of the drive shaft component. In other regions in the axial and/or radial direction, it is also possible to deviate from this rotational angle.

The arrangement of the fibers may in particular take the form of depositing the fibers without crossing points and/or with minimal fiber undulation.

A winding method, a braiding method, a TFP method or a combination of the methods may be used for introducing the fibers.

Since fiber production methods can often efficiently produce rotationally symmetrical components, in one embodiment production produces two symmetrical parts, which are then separated into two drive shaft components.

Furthermore, the problem is also addressed by a gas turbine engine for an aircraft which comprises the following:
a core engine comprising a turbine, a compressor, and a core shaft connecting the turbine to the compressor;
a fan which is positioned upstream of the core engine, wherein the fan comprises a plurality of fan blades; and
a gear box, which can be driven by the core shaft, wherein the fan can be driven by means of the gear box at a lower rotational speed than the core shaft, wherein a drive shaft component according to at least one of claims 1 to 14 is connected to the gear box, in particular on the output side of the gear box.

As noted elsewhere herein, the present disclosure may relate to a gas turbine engine, e.g. an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be particularly, although not exclusively, advantageous for geared fans, which are driven via a gear box. Accordingly, the gas turbine engine may comprise a gear box which is driven via the core shaft and the output of which drives the fan in such a way that it has a lower rotational speed than the core shaft. The input to the gear box may be effected directly from the core shaft, or indirectly via the core shaft, for example via a spur shaft and/or spur gear. The core shaft may be rigidly connected to the turbine and the compressor, such that the turbine and compressor rotate at the same rotational speed (with the fan rotating at a lower rotational speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, the second compressor, and the second core shaft may be arranged to rotate at a higher speed than the first core shaft.

In such an arrangement, the second compressor may be positioned axially downstream of the first compressor. The second compressor may be arranged to receive (for example directly receive, for example via a generally annular duct) a flow from the first compressor.

The gear box may be designed to be driven by the core shaft that is configured to rotate (for example in use) at the lowest rotational speed (for example the first core shaft in the example above). For example, the gear box may be designed to be driven only by the core shaft that is configured to rotate (for example in use) at the lowest rotational speed (for example only by the first core shaft and not the second core shaft in the example above). Alternatively, the gear box may be designed to be driven by one or more shafts, for example the first and/or second shaft in the example above.

In a gas turbine engine as described and/or claimed herein, a combustor may be provided axially downstream of the fan and compressor (or compressors). For example, the combustor may be directly downstream of (for example at the exit of) the second compressor if a second compressor is provided. By way of a further example, the flow at the exit of the compressor may be supplied to the inlet of the second turbine if a second turbine is provided. The combustor may be provided upstream of the turbine(s).

The or each compressor (for example the first compressor and the second compressor as described above) may comprise any number of stages, for example multiple stages. Each stage may comprise a row of rotor blades and a row of stator blades, which may be variable stator blades (i.e. the angle of incidence may be variable). The row of rotor blades and the row of stator blades may be axially offset with respect to one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset with respect to one another.

Each fan blade may have a radial span extending from a root (or a hub) at a radially inner location which is flowed over by gas, or from a position of 0% span, to a tip with a 100% span. The ratio of the radius of the fan blade at the hub to the radius of the fan blade at the tip may be less than (or of the order of magnitude of) any of the following: 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range bounded by any two values in the previous sentence (i.e. the values may form upper or lower bounds). These ratios can commonly be referred to as the hub-to-tip ratio. The radius at the hub and the radius at the tip may both be measured at the leading edge (or the axially forwardmost edge) of the blade. The hub-to-tip ratio refers, of course, to that portion of the fan blade which is flowed over by gas, i.e. the portion radially outside any platform.

The radius of the fan may be measured between the engine centerline and the tip of the fan blade at its leading edge. The diameter of the fan (which can generally be double the radius of the fan) can be larger than (or of the order of magnitude of): 250 cm (approximately 100 inches), 260 cm (approximately 102 inches), 270 cm (approximately 105 inches), 280 cm (approximately 110 inches), 290 cm (approximately 115 inches), 300 cm (approximately 120 inches), 310 cm (approximately 122 inches), 320 cm (approximately 125 inches), 330 cm (approximately 130 inches), 340 cm (approximately 135 inches), 350 cm (approximately 138 inches), 360 cm (approximately 140 inches), 370 cm (approximately 145 inches), 380 cm (approximately 150 inches) or 390 cm (approximately 155 inches). The fan diameter may be in an inclusive range bounded by any two of the values in the previous sentence (i.e. the values may form upper or lower bounds).

The speed of the fan may vary in operation. Generally, the speed is lower for fans with a larger diameter. Purely as a non-limiting example, the rotational speed of the fan under cruise conditions may be less than 2500 rpm, for example less than 2300 rpm. Purely as a further non-limiting example, the rotational speed of the fan under cruise conditions for an engine having a fan diameter in the range of from 250 cm to 300 cm (for example 250 cm to 280 cm) may also be in the range of from 1700 rpm to 2500 rpm, for example in the range of from 1800 rpm to 2300 rpm, for example in the range of from 1900 rpm to 2100 rpm. Purely as a further non-limiting example, the speed of the fan under cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

During the use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH of the flow. A fan tip loading may be defined as dH/Uₜᵢₚ², where dH is the enthalpy rise (for example the average 1-D enthalpy rise) across the fan and Uₜᵢₚ is the (translational) speed of the fan tip, for example at the leading edge of the tip (which may be defined as fan tip radius at the leading edge multiplied by angular speed). The fan tip loading under cruise conditions may be more than (or of the order of magnitude of): 0.3, 0.31, 0.32, 0.33, 0.34, 0.35, 0.36, 0.37, 0.38, 0.39, or 0.4 (wherein all units in this passage are J kg⁻¹ K⁻¹/(m s⁻¹)²). The fan tip loading may be in an inclusive range bounded by any two of the values in the previous sentence (i.e. the values may form upper or lower bounds).

Gas turbine engines according to the present disclosure can have any desired bypass ratio, wherein the bypass ratio is defined as the ratio of the mass flow rate of the flow through the bypass duct to the mass flow rate of the flow through the core under cruise conditions. In the case of some arrangements, the bypass ratio can be more than (or of the order of magnitude of): 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by an engine nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). As a non-limiting example, the overall pressure ratio of a gas turbine engine as described and/or claimed herein at cruising speed may be greater than (or of the order of): 35, 40, 45, 50, 55, 60, 65, 70, 75. The overall pressure ratio may be in an inclusive range bounded by any two of the values in the previous sentence (i.e. the values may form upper or lower bounds).

The specific thrust of an engine can be defined as the net thrust of the engine divided by the total mass flow through the engine. The specific thrust of an engine as described and/or claimed herein under cruise conditions may be less than (or of the order of): 110 N kg⁻¹ s, 105 N kg⁻¹ s, 100 N kg⁻¹ s, 95 N kg⁻¹ s, 90 N kg⁻¹ s, 85 N kg⁻¹ s or 80 N kg⁻¹ s. The specific thrust may be in an inclusive range bounded by any two of the values in the previous sentence (i.e. the values may form upper or lower bounds). Such engines can be particularly efficient in comparison with conventional gas turbine engines.

A gas turbine engine as described and/or claimed herein may have any desired maximum thrust. Purely as a non-limiting example, a gas turbine as described and/or claimed herein can be capable of generating a maximum thrust of at least (or of the order of): 160 kN, 170 kN, 180 kN, 190 kN, 200 kN, 250 kN, 300 kN, 350 kN, 400 kN, 450 kN, 500 kN or 550 kN. The maximum thrust may be in an inclusive range bounded by any two of the values in the previous sentence (i.e. the values may form upper or lower bounds). The thrust referred to above may be the maximum net thrust under standard atmospheric conditions at sea level plus 15° C. (ambient pressure 101.3 kPa, temperature 30° C.), with the engine static.

In use, the temperature of the flow at the entry to the high-pressure turbine can be particularly high. This temperature, which may be referred to as TET, may be measured at the exit to the combustor, for example immediately upstream of the first turbine blade, which itself may be referred to as a nozzle guide blade. At cruising speed, the TET may be at least (or of the order of): 1400 K, 1450 K, 1500 K, 1550 K, 1600 K or 1650 K. The TET at cruising speed may be in an inclusive range bounded by any two of the values in the previous sentence (i.e. the values may form upper or lower bounds). The maximum TET in the use of the engine can be at least (or of the order of), for example: 1700 K, 1750 K, 1800 K, 1850 K, 1900 K, 1950 K or 2000 K. The maximum TET may be in an inclusive range bounded by any two of the values in the previous sentence (i.e. the values may form upper or lower bounds). The maximum TET can occur, for example, under a high thrust condition, for example under a maximum take-off thrust (MTO) condition.

A fan blade and/or aerofoil portion of a fan blade described and/or claimed herein may be produced from any suitable material or combination of materials. For example at least a part of the fan blade and/or aerofoil may be produced at least in part from a composite, for example a metal matrix composite and/or an organic matrix composite, such as carbon fiber. As a further example, at least a part of the fan blade and/or aerofoil may be produced at least in part from a metal, such as e.g. a titanium based metal or an aluminum based material (such as e.g. an aluminum-lithium alloy) or a steel-based material. The fan blade may comprise at least two regions produced using different materials. For example, the fan blade may have a protective leading edge, which is produced using a material that is better able to resist impact (for example from birds, ice or other material) than the rest of the blade. Such a leading edge may, for example, be produced using titanium or a titanium-based alloy. Thus, purely as an example, the fan blade may have a carbon-fiber or aluminum based body (such as an aluminum-lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage with a corresponding slot in the hub (or disk). Purely as an example, such a fixture may be in the form of a dovetail that may slot into and/or be brought into engagement with a corresponding slot in the hub/disk in order to fix the fan blade to the hub/disk. As a further example, the fan blades may be formed integrally with a central portion. Such an arrangement can be referred to as a blisk or a bling. Any suitable method can be used to produce such a blisk or such a bling. For example, at least a part of the fan blades may be machined from a block and/or at least part of the fan blades may be attached to the hub/disk by welding, such as e.g. linear friction welding.

The gas turbine engines described and/or claimed herein may or may not be provided with a variable area nozzle (VAN). Such a variable area nozzle may allow the exit area of the bypass duct to be varied in operation. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such cruise conditions may be conventionally defined as the conditions during the middle part of the flight, for example the conditions experienced by the aircraft and/or the engine between (in terms of time and/or distance) the end of the ascent and the start of the descent.

Purely as an example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any speed within these ranges may be the cruise condition. For some aircraft, the cruise condition may be outside these ranges, for example below Mach 0.7 or above Mach 0.9.

Purely as an example, the cruise conditions may correspond to standard atmospheric conditions at an altitude that is in the range of from 10 000 m to 15 000 m, for example in the range of from 10 000 m to 12 000 m, for example in the range of from 10 400 m to 11 600 m (around 38 000 ft), for example in the range of from 10 500 m to 11 500 m, for example in the range of from 10 600 m to 11 400 m, for example in the range of from 10 700 m (around 35 000 ft) to 11 300 m, for example in the range of from 10 800 m to 11 200 m, for example in the range of from 10 900 m to 11 100 m, for example of the order of magnitude of 11 000 m. The cruise conditions may correspond to standard atmospheric conditions at any given altitude in these ranges.

Purely as an example, the cruise conditions may correspond to the following: a forward Mach number of 0.8, a pressure of 23 000 Pa and a temperature of −55° C.

As used anywhere herein, “cruising speed” or “cruise conditions” can mean the aerodynamic design point. Such an aerodynamic design point (or ADP) may correspond to the conditions (comprising, for example, the Mach number, environmental conditions and thrust demand) for which the fan is designed to operate. This may mean, for example, the conditions at which the fan (or gas turbine engine) is designed to have optimum efficiency.

During operation, a gas turbine engine described and/or claimed herein may be operated under the cruise conditions defined elsewhere herein. Such cruise conditions may be determined by the cruise conditions (for example the conditions during the middle part of the flight) of an aircraft on which at least one (for example two or four) gas turbine engine(s) may be mounted in order to provide propulsive thrust.

It is self-evident to a person skilled in the art that a feature or parameter described in relation to any one of the above aspects may be applied to any other aspect, unless they are mutually exclusive. Furthermore, any feature or any parameter described here may be applied to any aspect and/or combined with any other feature or parameter described here, unless they are mutually exclusive.

Embodiments will now be described by way of example with reference to the figures, in which:

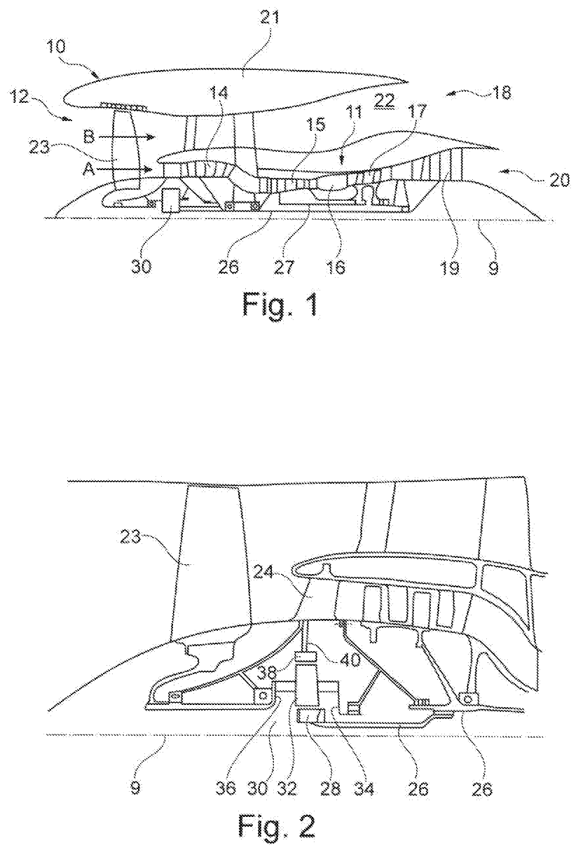

FIG. 1 shows a sectional lateral view of a gas turbine engine;

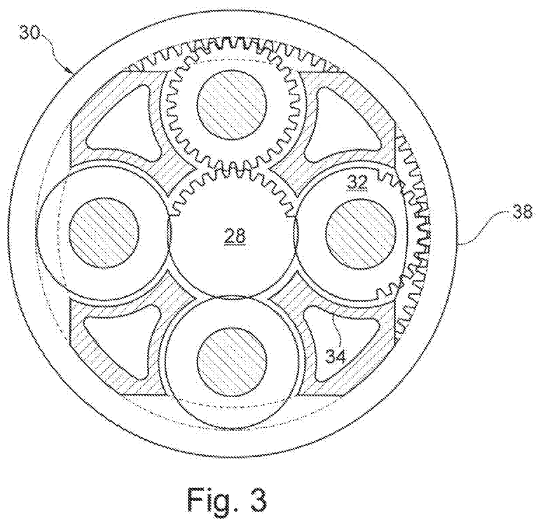

FIG. 2 shows a close-up sectional lateral view of an upstream portion of a gas turbine engine;

FIG. 3 shows a partially cut-away view of a gear box for a gas turbine engine;

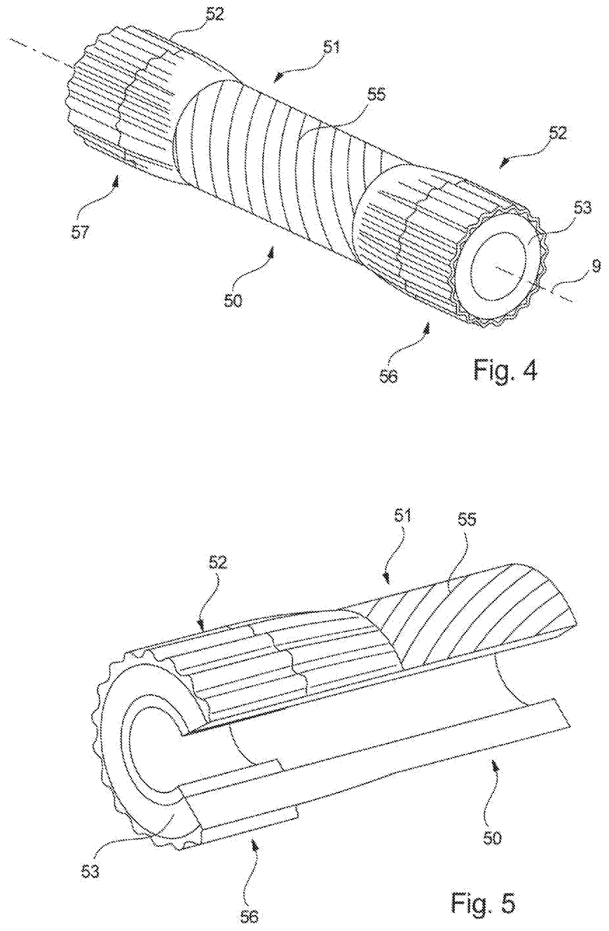

FIG. 4 shows a perspective representation of a first embodiment of a drive shaft component;

FIG. 5 shows a sectional view of an embodiment of a drive shaft component according to FIG. 4;

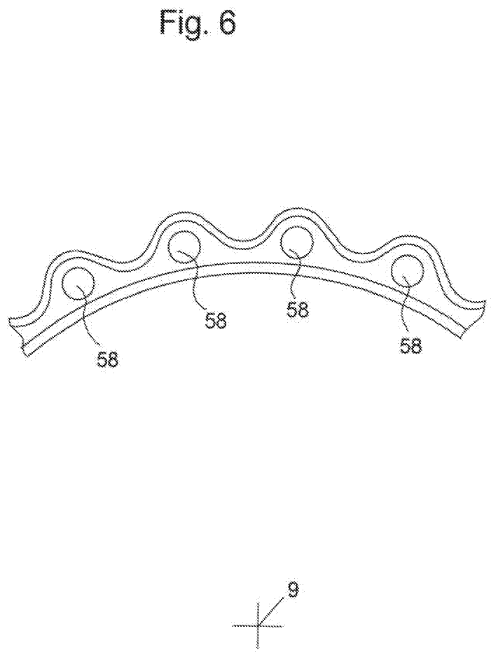

FIG. 6 shows a view of a detail of a profiling at the load introduction point or load delivery point;

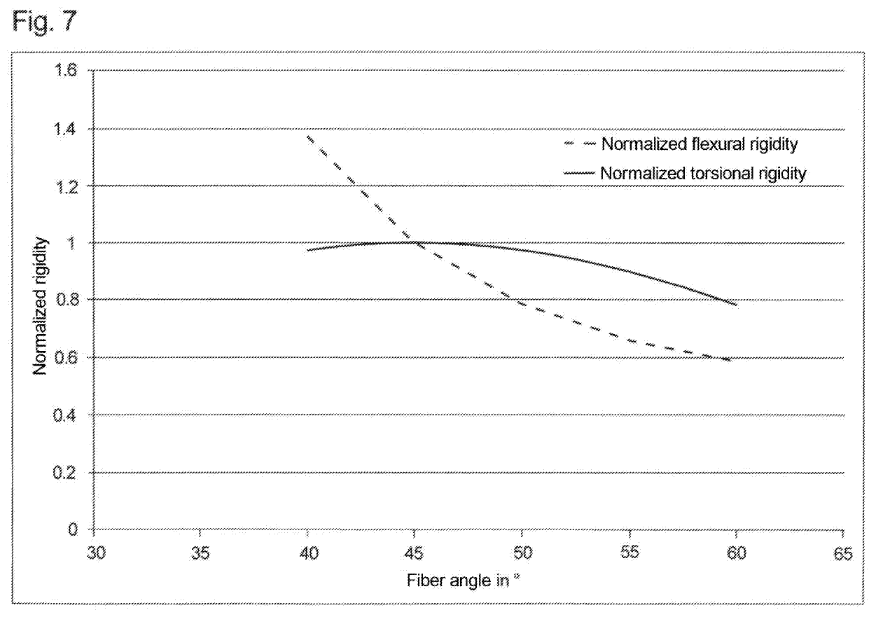

FIG. 7 shows a representation of the normalized flexural rigidity and the normalized torsional rigidity in dependence on the fiber angle.

FIG. 1 illustrates a gas turbine engine 10 having a main axis of rotation 9. The gas turbine engine 10 comprises an air inlet 12 and a fan 23 that generates two air flows: a core air flow A and a bypass air flow B. The gas turbine engine 10 comprises a core 11 that receives the core air flow A. When viewed in the order corresponding to the axial direction of flow, the core engine 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear box 30.

During operation, the core air flow A is accelerated and compressed by the low-pressure compressor 14 and directed into the high-pressure compressor 15, where further compression takes place. The compressed air exhausted from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being expelled through the nozzle 20 to provide some thrust force. The high-pressure turbine 17 drives the high-pressure compressor 15 by means of a suitable connection shaft 27. The fan 23 generally provides the major part of the propulsive thrust. The epicyclic planetary gear box 30 is a reduction gear box.

An exemplary arrangement for a geared fan gas turbine engine 10 is shown in FIG. 2. The low-pressure turbine 19 (see FIG. 1) drives the shaft 26, which is coupled to a sun gear 28 of the epicyclic planetary gear box 30. Radially to the outside of the sun gear 28 and meshing therewith are a plurality of planet gears 32 that are coupled to one another by a planet carrier 34. The planet carrier 34 guides the planet gears 32 in such a way that they circulate synchronously around the sun gear 28, whilst enabling each planet gear 32 to rotate about its own axis. The planet carrier 34 is coupled via linkages 36 to the fan 23 in order to drive its rotation about the engine axis 9. Radially to the outside of the planet gears 32 and meshing therewith is an annulus or ring gear 38 that is coupled, via linkages 40, to a stationary supporting structure 24.

Note that the terms “low-pressure turbine” and “low-pressure compressor” as used herein may be taken to mean the lowest-pressure turbine stage and lowest-pressure compressor stage (i.e. not including the fan 23) respectively and/or the turbine and compressor stages that are connected together by the connecting shaft 26 with the lowest rotational speed in the engine (i.e. not including the gear-box output shaft that drives the fan 23). In some literature, the “low-pressure turbine” and “low-pressure compressor” referred to herein may alternatively be known as the “intermediate-pressure turbine” and “intermediate-pressure compressor”. Where such alternative nomenclature is used, the fan 23 can be referred to as a first, or lowest-pressure, compression stage.

The epicyclic planetary gear box 30 is shown by way of example in greater detail in FIG. 3. The sun gear 28, planet gears 32 and ring gear 38 in each case comprise teeth on their periphery to allow intermeshing with the other gearwheels. However, for clarity, only exemplary portions of the teeth are illustrated in FIG. 3. Although four planet gears 32 are illustrated, it will be apparent to a person skilled in the art that more or fewer planet gears 32 can be provided within the scope of protection of the claimed invention. Practical applications of an epicyclic planetary gear box 30 generally comprise at least three planet gears 32.

The epicyclic planetary gear box 30 illustrated by way of example in FIGS. 2 and 3 is a planetary gear box in which the planet carrier 34 is coupled to an output shaft via linkages 36, with the ring gear 38 being fixed. However, any other suitable type of planetary gear box 30 may be used. As a further example, the planetary gear box 30 may be a star arrangement, in which the planet carrier 34 is held fixed, with the ring gear (or annulus) 38 allowed to rotate. In such an arrangement, the fan 23 is driven by the ring gear 38. As a further alternative example, the gear box 30 can be a differential gear box in which the ring gear 38 and the planet carrier 34 are both allowed to rotate.

It is self-evident that the arrangement shown in FIGS. 2 and 3 is merely an example, and various alternatives fall within the scope of protection of the present disclosure. Purely by way of example, any suitable arrangement may be used for locating the gear box 30 in the gas turbine engine 10 and/or for connecting the gear box 30 to the gas turbine engine 10. As a further example, the connections (e.g. the linkages 36, 40 in the example of FIG. 2) between the gear box 30 and other parts of the gas turbine engine 10 (such as e.g. the input shaft 26, the output shaft and the fixed structure 24) may have a certain degree of stiffness or flexibility. As a further example, any suitable arrangement of the bearings between rotating and stationary parts of the gas turbine engine 10 (for example between the input and output shafts of the gear box and the fixed structures, such as the gear-box casing) may be used, and the disclosure is not limited to the exemplary arrangement of FIG. 2. For example, where the gear box 30 has a star arrangement (described above), a person skilled in the art would readily understand that the arrangement of output and supporting linkages and bearing positions would usually be different than that shown by way of example in FIG. 2.

Accordingly, the present disclosure extends to a gas turbine engine having any arrangement of types of gear box (for example star or epicyclic-planetary), supporting structures, input and output shaft arrangement, and bearing locations.

Optionally, the gear box may drive additional and/or alternative components (e.g. the intermediate-pressure compressor and/or a booster compressor).

Other gas turbine engines to which the present disclosure can be applied may have alternative configurations. For example, engines of this type may have an alternative number of compressors and/or turbines and/or an alternative number of connecting shafts. As a further example, the gas turbine engine shown in FIG. 1 has a split flow nozzle 20, 22 meaning that the flow through the bypass duct 22 has its own nozzle that is separate from and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the example described relates to a turbofan engine, the disclosure may be applied, for example, to any type of gas turbine engine, such as e.g. an open-rotor engine (in which the fan stage is not surrounded by an engine nacelle) or a turboprop engine. In some arrangements, the gas turbine engine 10 may not comprise a gear box 30.

The geometry of the gas turbine engine 10, and components thereof, is/are defined by a conventional axis system, comprising an axial direction (which is aligned with the axis of rotation 9), a radial direction (in the bottom-to-top direction in FIG. 1), and a circumferential direction (perpendicular to the view in FIG. 1). The axial, radial and circumferential directions run so as to be mutually perpendicular.

In FIG. 4, a first embodiment of a fundamentally rotationally symmetrical drive shaft component 50 is illustrated in a perspective view. This drive shaft component, configured as a hollow shaft, is designed as part of a drive shaft for the gear box 30 (see FIG. 1), i.e. the drive shaft component 50 is arranged on the input side of the gear box 30.

The load introduction point 56 is in this case connected to the low-pressure turbine 19 (not illustrated here)—possibly by means of a more complex shaft arrangement. Serving here for this purpose is a metal insert 53, which is only schematically indicated. Lying axially further forward is the load delivery point 57, which is connected to the sun gear 28 of the gear box. Respectively connected at the load introduction point 56 and the load delivery point 57 is a form-fitting connection element 52 in the form of a profiling, which is illustrated in cross section in FIG. 5.

The drive shaft component 50 has at least partially a region 51 comprising carbon-fiber reinforced plastic, the fibers 55 in this region 51 being arranged only in an angular range of +/−40° to 50°, in particular of +/−42° to 48°, here however +/−45°, in relation to the main axis of rotation 9 of the drive shaft component 50. In principle, other fibers (metal, ceramic, synthetic, etc.) may also be used on their own or in combination.

This achieves a structure that is compliant in the axial and radial directions, and so the drive train is decoupled from movements of the gear box 30. The fibers 55 laid at an angle of substantially +/−45 ° efficiently lead away torsional loads. The fibers 55 are in each case laid as monolayers, the fibers being incorporated in the matrix in particular without crossing, i.e. the fiber angle remains the same.

The angle is measured here by using a projection of the fiber winding onto the main axis of rotation 9. The region 55 should be understood here in the axial extent. In alternative embodiments, individual layers may be laid substantially at +/−45°, while other layers have a different angle.

In FIG. 7 and the following table, the dependence of the normalized flexural rigidity and the normalized torsional rigidity on the angle of the fibers is illustrated.

In the angular range with a 5° deviation either way from the 45° angle, in FIG. 8 only a minimal influence on the torsional rigidity, but a significant influence on the flexural rigidity can be seen. Consequently, in the case of the embodiment described, the flexural rigidity can be set within wide ranges without any influence on the torsional rigidity. The fiber volume content has a linear effect on both variables.

| | Normalized flexural | Normalized torsional |
|---|---|---|
| Fiber angle in ° | rigidity | rigidity |
| +−40° | 136.30% | 97.40% |
| +−45° | 100.00% | 100.00% |
| +−50° | 78.30% | 97.40% |
| +−55° | 65.60% | 89.70% |
| +−60° | 58.30% | 78.10% |

Various methods may be used for producing such an embodiment, and these methods can also be combined with one another. Thus, e.g., a winding method, a braiding method, a TFP method (Tailored Fiber Process) or a combination of the methods may be used.

When using a braiding method, the fibers 55 may e.g. also be laid over steps. One example of a combination of methods is, e.g. the use of a TFP preform that is subsequently overwound or overbraided.

In the embodiment illustrated here, the drive shaft component 50 has a length of 500 mm. The load introduction and load delivery points 56, 57 have diameters of between 150 and 200 mm. Typically, such a drive shaft component will transmit a torsional moment of 100 000 to 200 000 Nm, at a rotational speed of between 1500 and 3000 rpm. These figures should be understood here as only given by way of example, since other design requirements also require different dimensioning of the drive shaft component 50.

In the embodiment illustrated, the drive shaft component 50, in particular the region 51 with fiber-reinforced plastic, is of a substantially cylindrical configuration, with a circular cross section. Alternatively, it is also possible that part of the drive shaft component 50 is of a conical design.

The embodiment according to FIG. 5 shows a sectional view through a load introduction point 56 according to the embodiment illustrated in FIG. 4.

In this case, the drive shaft component 50 is designed as a hollow shaft, which is made up of fiber-reinforced plastics material. Arranged in the interior of the hollow shaft is a supporting element 53, for example in the form of a metal ring.

The profiling on the outer circumference of the drive shaft component 50 at the load introduction point 56 or the load delivery point 57 is formed by filling elements 58 (see FIG. 6) being applied to an inner enveloping surface of the drive shaft component 50, the filling elements 58 then being overwound by layers of the fiber-reinforced plastic. In the embodiment illustrated, filling elements 58 with a circular cross section are used by way of example, so that a shaft-like outer contour forms.

It is also possible that the fiber-reinforced plastic layers are wound on a core which has a polygonal cross section.

It is self-evident that the invention is not limited to the embodiments described above and that various modifications and improvements may be made without departing from the concepts described herein. Except where mutually exclusive, any of the features can be employed separately or in combination with any other features, and the disclosure extends to and includes all combinations and sub-combinations of one or more features that are described herein.

### LIST OF REFERENCE SIGNS

9 Main axis of rotation
10 Gas turbine engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Fan
24 Stationary supporting structure
26 Shaft
27 Connecting shaft
28 Sun gear
30 Gear box
32 Planet gears
34 Planet carrier
36 Linkage
38 Ring gear
40 Linkage
50 Drive shaft component
51 Region comprising fiber reinforced plastic
52 Form-fitting connection element
53 Supporting element, metal insert
55 Fibers
56 Load introduction point
57 Load delivery point
58 Filling element
A Core air flow
B Bypass air flow

1. A drive shaft component, which can be connected or is connected to the input side of a gear box in a gas turbine engine, in particular an aircraft engine,
wherein
the drive shaft component) has partially a region comprising fiber reinforced plastic, the fibers in this region being arranged only in an angular range of +/−40° to 50°, in particular of +/−42° to 48°, most particularly +/−45°, in relation to the main axis of rotation of the drive shaft component, and in that between the load introduction point and the load delivery point there is arranged a conical region, which tapers in the axial direction from the load introduction point to the load delivery point, wherein at the axial center of the conical region the fibers are arranged in an angular range of +/−40° to 50°, in particular of +/−42° to 48°, most particularly +/−45°, in relation to the main axis of rotation, the angle becoming greater in the direction of a larger diameter and the angle becoming smaller in the direction of a smaller diameter.

2. The drive shaft component according to claim 1, wherein a metal insert is arranged at a load introduction point and/or at a load delivery point of the drive shaft component.

3. The drive shaft component according to claim 1, wherein the fibers are at least partially formed as monolayers.

4. (canceled)

5. (canceled)

6. The drive shaft component according to claim 1, the fiber volume content is at a maximum in the conical region, even independently of the angle of the fiber deposition.

7. The drive shaft component according to claim 1, wherein it is designed as a hollow shaft, the wall thickness being constant or the wall thickness increasing from the load introduction point to the load delivery point.

8. The drive shaft component according to claim 1, wherein additional layers of fibers, in particular in a load-adapted orientation, are arranged in the load introduction region and/or the load delivery region.

9. The drive shaft component according to claim 1, wherein the drive shaft component is designed as part of a drive shaft for a gear box.

10. The drive shaft component according to claim 1, wherein the fiber-reinforced plastic comprises carbon fibers, metal filaments, synthetic fibers, in particular aramids and/or ceramic fibers.

11. The drive shaft component according to claim 1, wherein a form-fitting connection element, in particular for a polygonal connection, is arranged at the load introduction point and/or at the load delivery point of the drive shaft component.

12. The drive shaft component according to claim 11, wherein the form-fitting connection element takes the form of a profiling of the outer side of the drive shaft component.

13. The drive shaft component according to claim 11, wherein a metal supporting element and/or a supporting element of fiber composite material is arranged in the interior of the drive shaft component.

14. The drive shaft component according to claim 11, wherein a pretensioning force is applied.

15. A method for producing a drive shaft component for the input side of a gear boxes in a gas turbine engine in particular an aircraft engine,
wherein
in one region fibers are incorporated in a matrix, the fibers in this region being arranged only in an angular range of +/−40° to 50°, in particular of +/−42° to 48°, most particularly +/−45°, in relation to the main axis of rotation of the drive shaft component, and at the axial center of a conical region, the fibers are arranged in an angular range of +/−40° to 50°, in particular of +/−42° to 48°, most particularly +/−45°, in relation to the main axis of rotation, the winding angle becoming greater in the direction of a larger diameter and the winding angle becoming smaller in the direction of a smaller diameter.

16. The method according to claim 15, wherein depositing the fibers is performed without crossing points and/or with minimal fiber undulation.

17. The method according to claim 15, wherein a winding method, a braiding method, a TFP method or a combination of the methods is used for introducing the fibers.

18. (canceled)

19. The method according to claim 18, wherein the fiber volume content is kept at a maximum in the conical region, even independently of the angle of the fiber deposition.

20. The method according to claim 15, wherein production produces two symmetrical parts, which are then separated into two drive shaft components.

21. The method according to claim 15, wherein the fiber-reinforced plastic comprises carbon fibers, metal filaments, synthetic fibers, in particular aramids and/or ceramic fibers.

22. A gas turbine engine for an aircraft, comprising the following:
a core engine comprising a turbine, a compressor, and a core shaft connecting the turbine to the compressor;
a fan, which is positioned upstream of the core engine, wherein the fan comprises a plurality of fan blades; and
a gear box, which can be driven by the core shaft, wherein the fan can be driven by means of the gear box at a lower rotational speed than the core shaft, wherein a drive shaft component according to claim 1 is connected to the gear box, in particular on the input side of the gear box.
